(19) United States
(12) Patent Application Publication
(10) Pub. No.: US 2007/0008822 A1
(43) Pub. Date: Jan. 11, 2007

(54) Adjustable global timepiece

(76) Inventor: Liming Chen, Hangzhou (CN)

Correspondence Address: ANNA WU, P.O. BOX 93286, CITY OF INDUSTRY, CA, 91715, US

(21) Appl. No.: 11/375,311

(22) Filed: Mar. 14, 2006

(30) Foreign Application Priority Data
Jul. 11, 2005 (WO) PCT/CN05/01013

(51) Int. Cl. G04B 19/22

(52) U.S. Cl. 368/21

(57) ABSTRACT

An adjustable global timepiece includes a minute pointer, a hour pointer, a movement mechanism, an inner time dial, a time zone dial, and an outer time dial. The movement mechanism has a shaft. The inner time dial has 12 or 24 blocks configured for displaying a first time in a first time zone. The inner dial is coupled to the shaft so as to be driven by the movement mechanism. The time zone dial has 12 or 24 blocks. The time zone dial is manually adjustably rotatable relative to the shaft. The outer time dial has 12 or 24 blocks configured for displaying a second time in a second time zone. The outer time dial has a time zone pointer located at the location of 12 or 24 o'clock thereof configured for indicating the second time zone. The outer time dial is manually adjustably rotatable relative to the shaft.

### BACKGROUND OF THE INVENTION

1. Field of the Invention

The present invention relates to timepieces, and particularly to an adjustable global timepiece.

2. Description of Prior Art

A traditional timepiece generally includes a case, a dial, a movement mechanism, and time pointers, i.e. a hour hand, a minute hand and a second hand. Such timepiece can only display the time in a local time zone and cannot instantly display the time in another time zone. However, for those people frequently traveling around the world, it becomes more and more important to understand and master the local time in different time zones. Under this kind of demand, the common timepiece will not be able to provide this kind of information. Gradually, various kinds of global timepiece have been developed to improve this inconvenient situation, which can show the local time all over the world through the reading of a single timepiece.

China patent application serial No. 03215040.7 discloses a global timepiece. The global timepiece includes a dial assembly, a movement mechanism, and a date memory. The dial assembly includes a time dial and a time zone dial. The movement mechanism has a main shaft. The main shaft extends through the time dial and engages with the time zone dial so as to drive the time zone to rotate. However, the global timepiece is unduly complex, compared with a traditional timepiece. It is difficult for a user to directly understand and master the time through a glance.

### SUMMARY OF THE INVENTION

Accordingly, an object of the present invention is to provide an adjustable global timepiece, which has a simple structure, and is easy and convenient for operation.

In order to achieve the above-mentioned object, an adjustable global timepiece is provided. The adjustable global timepiece includes a minute pointer, a hour pointer, a movement mechanism, an inner time dial, a time zone dial and an outer time dial. The movement mechanism has a shaft. The inner time dial has 24 equally divided labeled blocks configured for displaying a first time in a first time zone. The inner dial is coupled to the shaft so as to be driven by the movement mechanism. The time zone dial has 24 equally divided labeled blocks. The time zone dial is manually adjustably rotatable relative to the shaft. The outer time dial has 24 equally divided labeled blocks configured for displaying a second time in a second time zone. The outer time dial has a time zone pointer located at the location of 24 o'clock thereof configured for indicating the second time zone. The outer time dial is manually adjustably rotatable relative to the shaft.

In another aspect of the present invention, an alternative adjustable global timepiece is provided. The adjustable global timepiece includes a minute pointer, a hour pointer, a movement mechanism, an inner time dial, a time zone dial and an outer time dial. The movement mechanism has a shaft. The inner time dial has 12 equally divided labeled blocks configured for displaying a first time in a first time zone. The inner dial is coupled to the shaft so as to be driven by the movement mechanism. The time zone dial has 12 equally divided labeled blocks. The time zone dial is manually adjustably rotatable relative to the shaft. The outer time dial has 12 equally divided labeled blocks configured for displaying a second time in a second time zone. The outer time dial has a time zone pointer located at the location of 12 o'clock thereof configured for indicating the second time zone. The outer time dial is manually adjustably rotatable relative to the shaft.

The adjustable global timepiece may further includes a mounting base with the inner time dial, the time zone dial, and the outer time dial being mounted thereon. Correspondingly, the mounting base has 12 or 24 equispaced first indentations, 12 or 24 resilient members and 12 or 24 beads. The resilient members and beads are received in the corresponding first indentations. The outer time dial has a lower surface with 12 or 24 equispaced second indentations defined therein for partially receiving the beads. The second indentations spatially correspond to the 12 or 24 equally divided labeled blocks of the outer time dial and the first indentations.

The outer time dial may advantageously have a peripheral portion raised relative to the mounting base for facilitating manually rotation thereof. The time zone dial may include a knob configured for facilitating manually rotation thereof. Alternatively, the adjustable global timepiece may further includes a gear mechanism configured for facilitating manually rotation of the time zone dial. The gear mechanism includes a linkage shaft having a first end and an opposite second end, a gear arranged at the first end, and a wind knob arranged at the second end. The gear is meshed with the time zone dial.

Compared with conventional global timepiece, the present global timepiece has the following advantages. Firstly, the global timepiece may employ driving means of a traditional timepiece, e.g. a clockwork, a movement mechanism, and so on. By simply modification of the traditional timepiece to further provide a time zone dial and an outer time dial, the global timepiece can thus display time in two global time zones by adjusting the relative position of the time zone dial, the outer time dial, and the inner time dial. Secondly, the time zone dial and the outer time dial may be manually operated without the need for extra driving mechanisms.

The above and other features of the invention, including various novel details of construction and combination of parts, will now be more particularly described with reference to the accompanying drawings, in which:

### BRIEF DESCRIPTION OF THE DRAWINGS

FIG. 1 is a schematic, top view of a global timepiece in accordance with a first preferred embodiment of the present invention;

FIG. 2 is a schematic, top view of a global timepiece in accordance with a second preferred embodiment of the present invention;

FIG. 3 is a schematic, cross-sectional view of a global timepiece in accordance with a third preferred embodiment of the present invention; and

FIG. 4 is a schematic, cross-sectional view of a global timepiece in accordance with a fourth preferred embodiment of the present invention

### DETAILED DESCRIPTION OF PREFERRED EMBODIMENTS

Reference will now be made to the drawings to describe the present invention in detail.

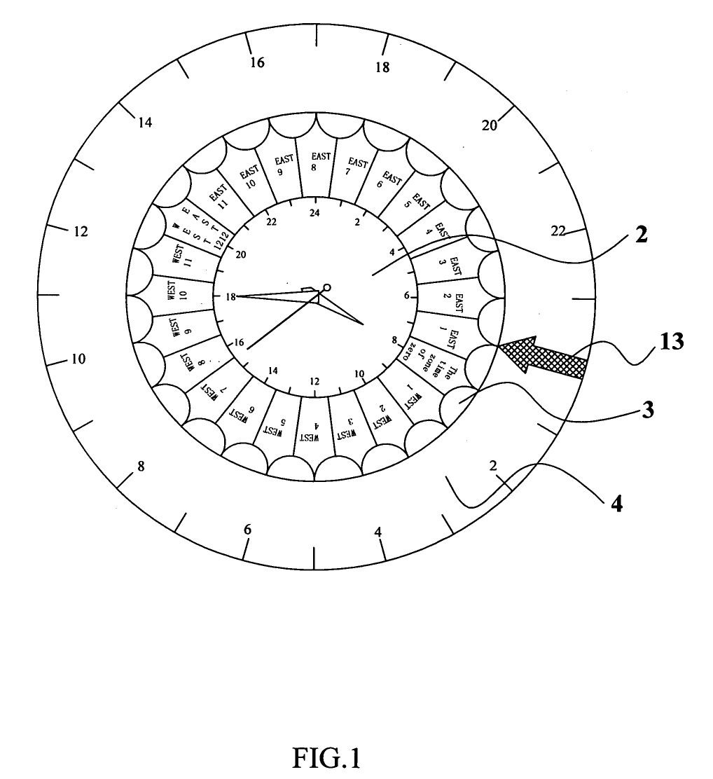

Referring to FIG. 1, this shows an adjustable global timepiece in accordance with a first preferred embodiment. The adjustable global timepiece beneficially includes an inner time dial 2, a time zone dial 3 and an outer time dial 4. The inner time dial 2 has 24 equally divided labeled blocks configured for displaying a first time in a first time zone. In the present embodiment, the adjustable global timepiece further includes a movement mechanism, a second pointer, minute pointer, a hour pointer, each of which may be replaced with a conventional configuration of a tradition timepiece. The movement mechanism has a shaft. The inner time dial 2 is coupled to the shaft so as to be driven by the movement mechanism. The time zone dial 3 has 24 equally divided labeled blocks. The time zone dial 3 is configured to be manually adjustably rotatable relative to the shaft. The outer time dial 4 has 24 equally divided labeled blocks configured for displaying a second time in a second time zone. The outer time dial 4 has a time zone pointer 13 located at the location of 24 o'clock thereof configured for indicating the second time zone. The outer time dial 4 is configured to be manually adjustably rotatable relative to the shaft.

In the illustrate exemplary embodiment, the 24 equally divided labeled blocks of the inner time dial 2 and outer time dial 4 correspond to 1 though 24 o'clock of a whole day, respectively. The 24 equally divided labeled blocks of the outer time dial 4 correspond to the 24 time zones, i.e. ZERO time zone, WEST 1 though WEST 12 (EAST 12), and EAST 12 though EAST 1, in a clockwise order.

In use, firstly, the time pointers, the inner time dial 2 and the time zone dial 3 are set to indicate the time in the first time zone. As shown in FIG. 1, in the present embodiment, the first time zone is EAST 8, the time zone dial is therefore adjusted such that the block of the time zone dial 3 that is labeled with EAST 8 is set to the location of 24 o'clock of the inner time dial 2. In addition, the time in the EAST 8 time zone is 7:48:38, the time pointers are then set with respect to the inner time dial 2 to indicate 7:48:38. Secondly, the outer time dial 4 is adjusted such that the time zone pointer 13 thereof points at the block of the time zone dial 3 that shows the second time zone, e.g. EAST 1 time zone, in the illustrated embodiment. As a result, the time that is indicated by the time pointers with respect to the outer time dial 4 is the time in the second time zone, i.e. 0:45:38 in EAST 1 time zone.

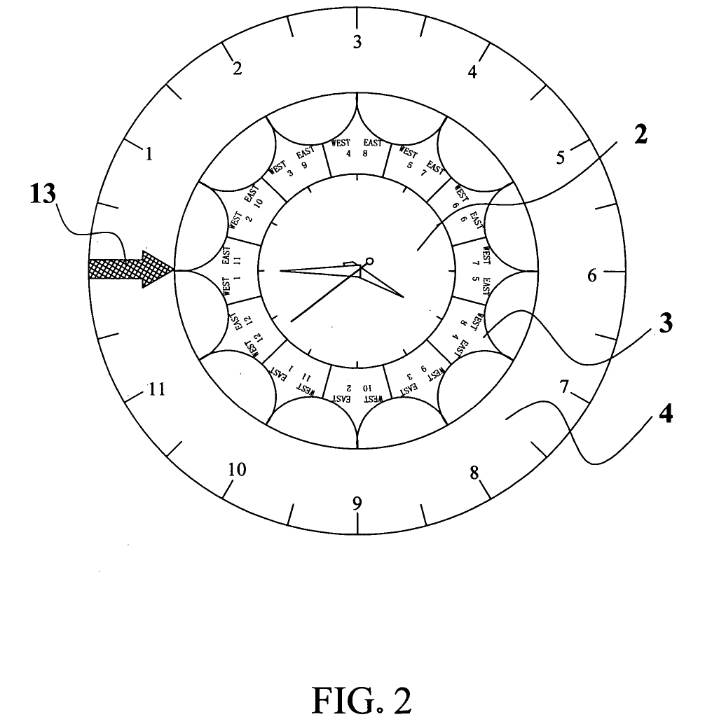

Referring to FIG. 2, this shows an adjustable global timepiece in accordance with a second preferred embodiment. The adjustable global timepiece beneficially includes an inner time dial 2, a time zone dial 3 and an outer time dial 4. The inner time dial 2 has 12 equally divided labeled blocks configured for displaying a first time in a first time zone. In the present embodiment, the adjustable global timepiece further includes a movement mechanism, a second pointer, minute pointer, a hour pointer, each of which may be replaced with a conventional configuration of a tradition timepiece. The movement mechanism has a shaft. The inner time dial 2 is coupled to the shaft so as to be driven by the movement mechanism. The time zone dial 3 has 12 equally divided labeled blocks. The time zone dial 3 is configured to be manually adjustably rotatable relative to the shaft. The outer time dial 4 has 12 equally divided labeled blocks configured for displaying a second time in a second time zone. The outer time dial 4 has a time zone pointer 13 located at the location of 12 o'clock thereof configured for indicating the second time zone. The outer time dial 4 is configured to be manually adjustably rotatable relative to the shaft.

In the illustrate exemplary embodiment, the 12 equally divided labeled blocks of the inner time dial 2 and outer time dial 4 correspond to 1 though 12 o'clock of a half day, respectively. As is known, the time differences between EAST 1 and WEST 11, EAST 2 and WEST 10, EAST 3 and WEST 9, . . . EAST 12 and WEST 12, are all 12 hours. Therefore, the 12 equally divided blocks of the outer time dial 4 are labeled to indicate the foregoing 12 pairs of time zones, i.e. EAST 1 and WEST 11, EAST 2 and WEST 10, EAST 3 and WEST 9, . . . EAST 12 and WEST 12.

In use, firstly, the time pointers, the inner time dial 2 and the time zone dial 3 are set to indicate the time in the first time zone. As shown in FIG. 1, in the present embodiment, the first time zone is EAST 8, the time zone dial is therefore adjusted such that the block of the time zone dial 3 that is labeled with EAST 8 is set to the location of 12 o'clock of the inner time dial 2. In addition, the time in the EAST 8 time zone is 3:45:38, the time pointers are then set with respect to the inner time dial 2 to indicate 7:48:38. Secondly, the outer time dial 4 is adjusted such that the time zone pointer 13 thereof points at the block of the time zone dial 3 that shows the second time zone, e.g. EAST 11 time zone, in the illustrated embodiment. As a result, the time that is indicated by the time pointers with respect to the outer time dial 4 is the time in the second time zone, i.e. 6:45:38 in EAST 11 time zone. Understandably, due to the time difference between the EAST 11 and WEST 1 is 12 hours, the time in the WEST 1 time zone is thus 18:45:38.

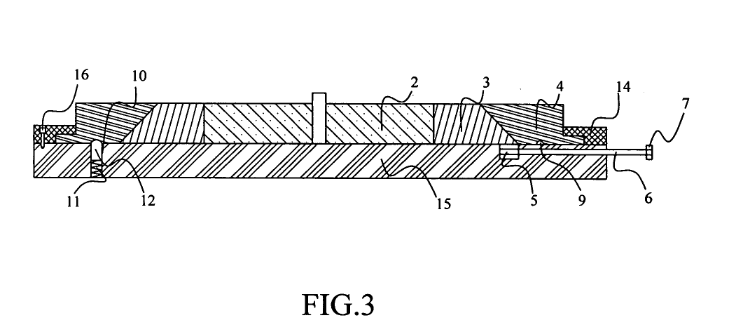

Referring to FIG. 3, this shows an adjustable global timepiece in accordance with a third preferred embodiment. The adjustable global timepiece beneficially includes a movement mechanism, an inner time dial 2, a time zone dial 3 and an outer time dial 4. The movement mechanism has a shaft. The inner time dial 2 is coupled to the shaft so as to be driven by the movement mechanism. The time zone dial 3 is configured to be manually adjustably rotatable relative to the shaft. In the illustrated exemplary embodiment, the time zone dial 3 is an annular dial concentrically surrounding the inner time dial 2 therein. The outer time dial 4 is configured to be manually adjustably rotatable relative to the shaft. Similarly, the outer time dial 4 is an annular dial concentrically surrounding the time zone dial 3 and the inner time dial 2 therein.

The adjustable global timepiece further includes a mounting base 15 with the inner time dial 2, the time zone dial 3, and the outer time dial 4 being mounted thereon. The outer time dial 4 has an engaging rim rotatably engaged with a mounting collar, which is, in turn, secured on the mounting base 15 using screws 16. The outer time dial 4 is rotatably mounted onto the mounting base 15 by securing the mounting collar to the mounting base 15. An interface between the outer time dial 4 and the time zone dial 3 is slanted so as to prevent the time zone dial 3 from detaching from the mounting base 15. In the case of the global timepiece of the first embodiment, the mounting base 15 may have 24 equispaced first indentations 10, 24 resilient members 11, such as springs and 24 beads 12. The resilient members 11 and beads 12 are received in the corresponding first indentations 10. The outer time dial 4 has a lower surface with 24 equispaced second indentations 9 defined therein for partially receiving the beads 12. The second indentations 9 spatially correspond to the 24 equally divided labeled blocks of the outer time dial 4 and the first indentations 10. The outer time dial 4 may advantageously have a peripheral portion raised relative to the mounting base 15 for facilitating manually rotation thereof. The adjustable global timepiece may further include a gear mechanism configured for facilitating manually rotation of the time zone dial 3. The gear mechanism includes a linkage shaft 6 having a first end and an opposite second end, a gear 5 arranged at the first end, and a wind knob 7 arranged at the second end. The gear 5 is meshed with a lower portion of the time zone dial 3. Thereby, the time zone dial 3 can be manually rotated by winding the wind knob 7.

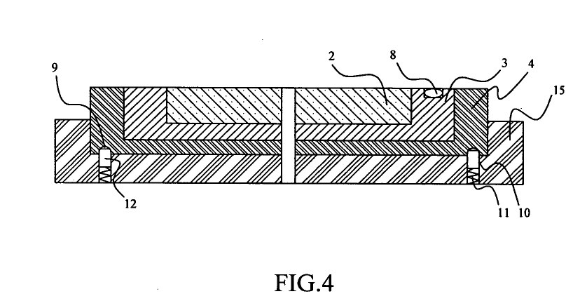

Referring to FIG. 4, this shows an adjustable global timepiece in accordance with a fourth preferred embodiment. The adjustable global timepiece beneficially includes a movement mechanism, an inner time dial 2, a time zone dial and an outer time dial. The movement mechanism has a shaft. The inner time dial 2 is coupled to the shaft so as to be driven by the movement mechanism. The time zone dial is configured to be manually adjustably rotatable relative to the shaft. In the illustrated exemplary embodiment, the time zone dial is a circular plate having an annular dial region 3 concentrically surrounding the inner time dial 2 therein. The outer time dial is configured to be manually adjustably rotatable relative to the shaft. Similarly, the outer time dial is a circular dial having an annular dial region 4 concentrically surrounding the time zone dial region 3 and the inner time dial 2 therein.

The adjustable global timepiece further includes a mounting base with the inner time dial, the time zone dial, and the outer time dial being mounted thereon. In the case of the global timepiece of the second embodiment, the mounting base 15 may have 12 equispaced first indentations 10, 24 resilient members 11, such as springs and 12 beads 12. The resilient members 11 and beads 12 are received in the corresponding first indentations 10. The outer time dial has a lower surface with 12 equispaced second indentations 9 defined therein for partially receiving the beads 12. The second indentations 9 spatially correspond to the 12 equally divided labeled blocks of the outer time dial and the first indentations 10. The outer time dial 4 may advantageously have a peripheral portion raised relative to the mounting base 15 for facilitating manually rotation thereof. The time zone dial may further include a knob 8 configured for facilitating manually rotation thereof.

Although the present invention has been described with reference to a specific embodiment, it should be noted that the described embodiment is not necessarily exclusive and that various changes and modifications may be made to the described embodiment without departing from the scope of the invention as defined by the appended claims.

What is claimed is:

1. An adjustable global timepiece comprising:
a minute pointer;
a hour pointer;
a movement mechanism having a shaft;
an inner time dial having 24 equally divided labeled blocks configured for displaying a first time in a first time zone, the inner dial being coupled to the shaft so as to be driven by the movement mechanism;
a time zone dial having 24 equally divided labeled blocks, the time zone dial being manually adjustably rotatable relative to the shaft; and
an outer time dial having 24 equally divided labeled blocks configured for displaying a second time in a second time zone, the outer time dial having a time zone pointer located at the location of 24 o'clock thereof configured for indicating the second time zone, the outer time dial being manually adjustably rotatable relative to the shaft.

2. The adjustable global timepiece as recited in claim 1, further comprising a mounting base with the inner time dial, the time zone dial, and the outer time dial being mounted thereon, wherein the mounting base has 24 equispaced first indentations, 24 resilient members and 24 beads, the resilient members and beads are received in the corresponding first indentations, the outer time dial has a lower surface with 24 equispaced second indentations defined therein for partially receiving the beads, the second indentations spatially correspond to the 24 equally divided labeled blocks of the outer time dial and the first indentations.

3. The adjustable global timepiece as recited in claim 1, wherein the outer time dial has a peripheral portion raised relative to the mounting base for facilitating manually rotation thereof.

4. The adjustable global timepiece as recited in claim 1, wherein the time zone dial includes a knob configured for facilitating manually rotation thereof.

5. The adjustable global timepiece as recited in claim 1, further comprising a gear mechanism configured for facilitating manually rotation of the time zone dial, wherein the gear mechanism comprises a linkage shaft having a first end and an opposite second end, a gear arranged at the first end, and a wind knob arranged at the second end, and the gear is meshed with the time zone dial.

6. An adjustable global timepiece comprising:
a minute pointer;
a hour pointer;
a movement mechanism having a shaft;
an inner time dial having 12 equally divided labeled blocks configured for displaying a first time in a first time zone, the inner dial being coupled to the shaft so as to be driven by the movement mechanism;
a time zone dial having 12 equally divided labeled blocks, the time zone dial being manually adjustably rotatable relative to the shaft; and
an outer time dial having 12 equally divided labeled blocks configured for displaying a second time in a second time zone, the outer time dial having a time zone pointer located at the location of 12 o'clock thereof configured for indicating the second time zone, the outer time dial being manually adjustably rotatable relative to the shaft.

7. The adjustable global timepiece as recited in claim 6, further comprising a mounting base with the inner time dial, the time zone dial, and the outer time dial being mounted thereon, wherein the mounting base has 12 equispaced first indentations, 12 resilient members and 12 beads, the resilient members and beads are received in the corresponding first indentations, the outer time dial has a lower surface with 12 equispaced second indentations defined therein for partially receiving the beads, the second indentations spatially correspond to the 12 equally divided labeled blocks of the outer time dial and the first indentations.

8. The adjustable global timepiece as recited in claim 6, wherein the outer time dial has a peripheral portion raised relative to the mounting base for facilitating manually rotation thereof.

9. The adjustable global timepiece as recited in claim 6, wherein the time zone dial includes a knob configured for facilitating manually rotation thereof.

10. The adjustable global timepiece as recited in claim 6, further comprising a gear mechanism configured for facilitating manually rotation of the time zone dial, wherein the gear mechanism comprises a linkage shaft having a first end and an opposite second end, a gear arranged at the first end, and a wind knob arranged at the second end, and the gear is meshed with the time zone dial.
